(19) United States
(12) Patent Application Publication
(10) Pub. No.: US 2013/0134641 A1
(43) Pub. Date: May 30, 2013

(54) VIBRATION ISOLATOR

(71) Applicant: Hirofumi Yanagi, Okayama (JP)

(72) Inventor: Hirofumi Yanagi, Okayama (JP)

(73) Assignee: KURASHIKI KAKO CO., LTD., Okayama (JP)

(21) Appl. No.: 13/306,814

(22) Filed: Nov. 29, 2011

(51) Int. Cl. F16F 7/00

(52) U.S. Cl. 267/141.2

(57) ABSTRACT

A vibration isolator includes an elastic body. The elastic body has a pair of main spring portions extending on both sides in a first axis-perpendicular direction from an outer peripheral surface of an inner cylinder body and coupled to an inner peripheral surface of an outer cylinder body, and an axis-perpendicular stopper portion protruding inward in a second axis-perpendicular direction perpendicular to the first axis-perpendicular direction from the inner peripheral surface of the outer cylinder body and restricting relative movement between the inner and outer cylinder bodies in the second axis-perpendicular direction. The vibration isolator further includes a first coupling elastic body provided between the axial stopper elastic body and one of the main spring portions to couple them together, and a second coupling elastic body provided between the axial stopper elastic body and the axis-perpendicular stopper portion to couple them together.

### CROSS-REFERENCE TO RELATED APPLICATION

This application claims priority to Japanese Patent Application No. 2010-125884 filed on Jun. 1, 2010, the disclosure of which including the specification, the drawings, and the claims is hereby incorporated by reference in its entirety.

### BACKGROUND

A technique disclosed herein relates to vibration isolators including an inner cylinder body, an outer cylinder body provided around the inner cylinder body, an elastic body provided between the inner and outer cylinder bodies to couple them together, and an axial stopper elastic body that is provided so that at least a part of the axial stopper elastic body is located axially outside an end face located on one side in an axial direction of the outer cylinder body, and that restricts relative movement between the inner and outer cylinder bodies in the axial direction.

Vibration isolators that are applied to engine mounts etc. of automobiles are known in the art.

For example, a vibration isolator described in Japanese Patent No. 4,290,073 includes an inner cylinder body, an outer cylinder body provided around the inner cylinder body, and an elastic body provided between the inner and outer cylinder bodies to couple them together. The inner cylinder body is coupled to a power plant as a source of vibrations, whereas the outer cylinder body is coupled to a vehicle body frame as a member that is to be subjected to vibrations.

This vibration isolator further includes an axial stopper elastic body that restricts relative movement between the inner and outer cylinder bodies in an axial direction. This axial stopper elastic body is provided on an axially outer surface of a flange that extends radially outward from an end located on one side in the axial direction of the outer cylinder body. The axial stopper elastic body restricts relative movement between the inner and outer cylinder bodies in the axial direction by contacting a bracket etc. on the side of the power plant.

### SUMMARY

In this vibration isolator, however, the flange is formed on the outer cylinder body as described above, which complicates the structure and increases the cost.

The technique disclosed herein was developed in view of the above problem, and it is an object of the technique to simplify the structure and reduce the cost of a vibration isolator including an inner cylinder body, an outer cylinder body provided around the inner cylinder body, an elastic body provided between the inner and outer cylinder bodies to couple them together, and an axial stopper elastic body that is provided so that at least a part of the axial stopper elastic body is located axially outside an end face located on one side in an axial direction of the outer cylinder body, and that restricts relative movement between the inner and outer cylinder bodies in the axial direction.

The technique disclosed herein is directed to a vibration isolator including: an inner cylinder body; an outer cylinder body provided around the inner cylinder body; an elastic body provided between the inner and outer cylinder bodies to couple the inner and outer cylinder bodies together; and an axial stopper elastic body that is provided so that at least a part of the axial stopper elastic body is located axially outside an end face located on one side in an axial direction of the outer cylinder body, and that restricts relative movement between the inner and outer cylinder bodies in the axial direction, wherein the elastic body has a pair of main spring portions extending on both sides in a first axis-perpendicular direction from an outer peripheral surface of the inner cylinder body and coupled to an inner peripheral surface of the outer cylinder body, and an axis-perpendicular stopper portion protruding inward in a second axis-perpendicular direction perpendicular to the first axis-perpendicular direction from the inner peripheral surface of the outer cylinder body and restricting relative movement between the inner and outer cylinder bodies in the second axis-perpendicular direction, the vibration isolator further including: a first coupling elastic body provided between the axial stopper elastic body and one of the main spring portions to couple the axial stopper elastic body and the one main spring portion together; and a second coupling elastic body provided between the axial stopper elastic body and the axis-perpendicular stopper portion to couple the axial stopper elastic body and the axis-perpendicular stopper portion together.

According to the above configuration, the vibration isolator is provided with the first coupling elastic body provided between the axial stopper elastic body and the one main spring portion to couple them together and the second coupling elastic body provided between the axial stopper elastic body and the axis-perpendicular stopper portion to couple them together. Thus, the axial stopper elastic body can be reliably held at its position by the first and second coupling elastic bodies. This eliminates the need to provide a flange on the outer cylinder body to place the axial stopper elastic body as in conventional examples, whereby the structure can be simplified and the cost can be reduced.

It is preferable that the axial stopper elastic body be provided so as to extend in a circumferential direction in a range from a position radially outside a portion where the one main spring portion is placed to a position radially outside a portion where the axis-perpendicular stopper portion is placed, as viewed in the axial direction.

In this configuration, the axial stopper elastic body is provided so as to extend in the circumferential direction in the range from the position radially outside the portion where the one main spring portion is placed to the position radially outside the portion where the axis-perpendicular stopper portion is placed, as viewed in the axial direction. This can simplify the respective structures of the first coupling elastic body provided between the axial stopper elastic body and the one main spring portion to couple them together, and the second coupling elastic body provided between the axial stopper elastic body and the axis-perpendicular stopper portion to couple them together.

It is preferable that the first and second coupling elastic bodies be molded integrally with the elastic body and the axial stopper elastic body.

In this configuration, since the first and second coupling elastic bodies are molded integrally with the elastic body and the axial stopper elastic body, the axial stopper elastic body can be more reliably held at its position by the first and second coupling elastic bodies.

It is preferable that the first coupling elastic body be provided between the axial stopper elastic body and a circumferential central portion of the one main spring portion.

Both circumferential ends of each main spring portion are more likely to be subjected to stress than the circumferential central portion thereof. Thus, providing the first coupling elastic body between one circumferential end of the one main spring portion and the axial stopper elastic body reduces durability of the one main spring portion.

In the above configuration, the first coupling elastic body is provided between the axial stopper elastic body and the circumferential central portion of the one main body portion which is less likely to be subjected to stress. This can suppress reduction in durability of the one main spring portion.

### BRIEF DESCRIPTION OF THE DRAWINGS

FIG. 1 is a front view showing a main body of an engine mount according to an example embodiment.

FIG. 2 is a side view showing the main body of the engine mount.

FIG. 3 is a perspective view showing the main body of the engine mount.

FIG. 4 is a front view of the engine mount.

### DETAILED DESCRIPTION

An example embodiment will be described in detail below with reference to the accompanying drawings.

In the example embodiment, a vibration isolator is applied to an engine mount of an automobile. This engine mount is interposed between a power plant and a vehicle body of an automobile, not shown, to support the load of the power plant and to absorb or attenuate vibrations received from the power plant, thereby suppressing transmission of the vibrations to the vehicle body.

That is, the engine mount is, e.g., a member that hangs an end located on the side of a transmission of the power plant mounted in a transverse direction in an engine room. The engine mount is placed so that the axis of an inner cylinder body extends substantially in a longitudinal direction of the vehicle body of the automobile.

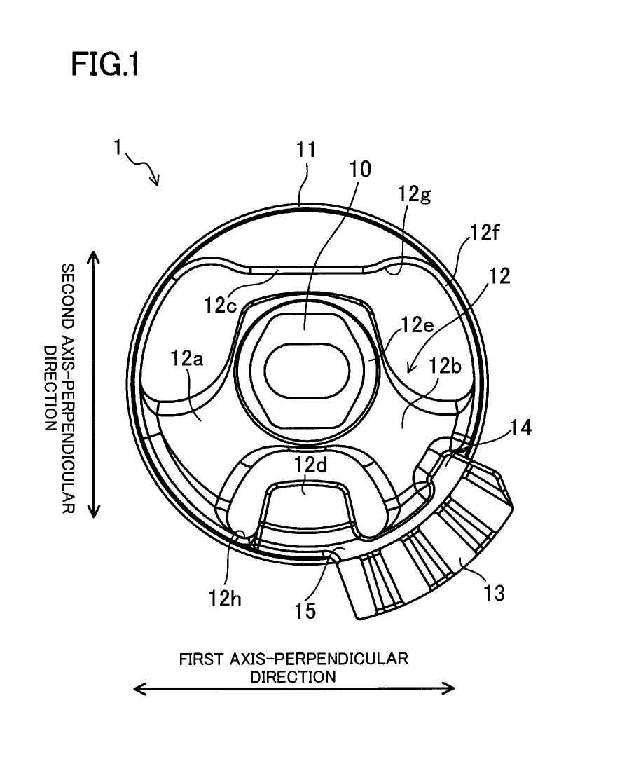

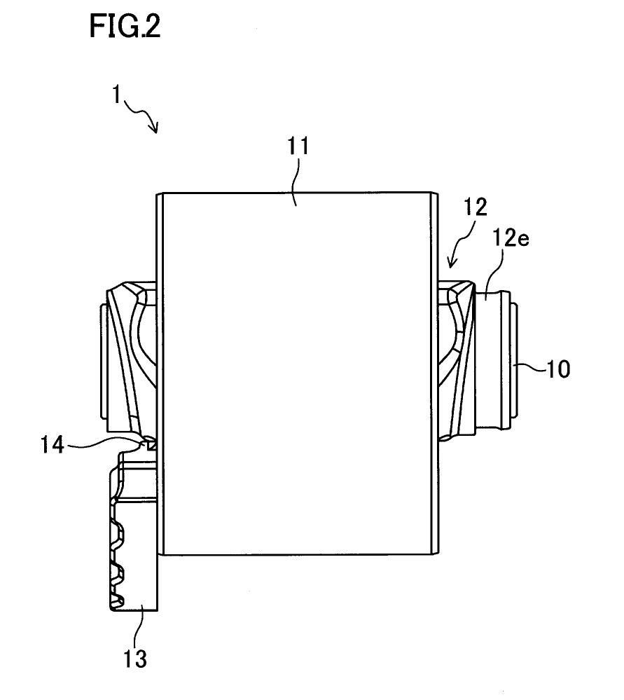

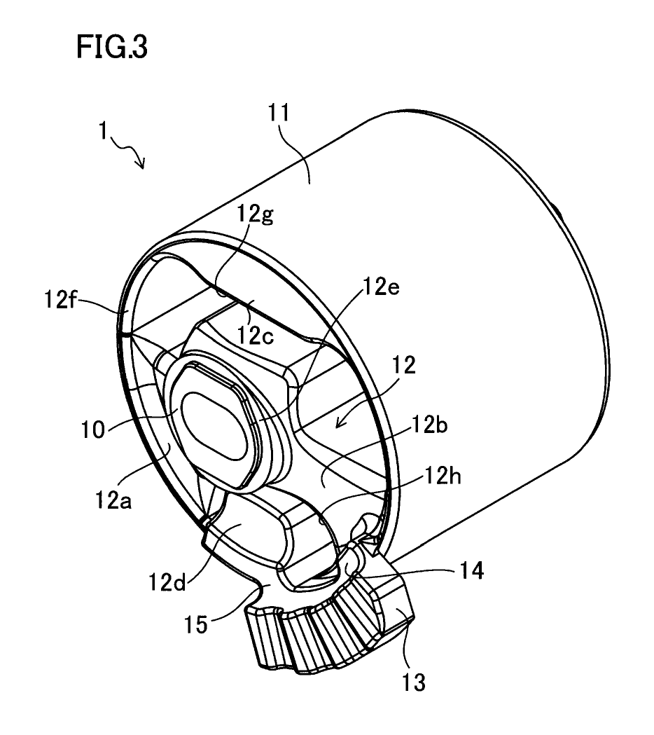

As shown in FIGS. 1-4, a main body (hereinafter referred to as the “mount main body”) 1 of an engine mount A includes a hollow cylindrical metal inner cylinder body 10, a hollow cylindrical metal outer cylinder body 11 provided coaxially around the inner cylinder body 10, a rubber elastic body 12 (corresponding to the “elastic body”) provided between the inner and outer cylinder bodies 10, 11 to couple them together, and an axial stopper rubber elastic body 13 (corresponding to the “stopper elastic body”) that is provided so that substantially the entire axial stopper rubber elastic body 13 is located axially outside an end face located on one side (the front side of the paper in FIG. 1) in an axial direction of the outer cylinder body 11, and that restricts relative movement between the inner and outer cylinder bodies 10, 11 in the axial direction. A cylindrical metal member 2 having the mount main body 1 press-fitted and fixed therein is coupled to a vehicle body frame (not shown) as a member that is to be subjected to vibrations, by metal brackets 20, 21 provided integrally with the metal member 2 so as to extend radially outward on the outer periphery of the metal member 2. On the other hand, the inner cylinder body 10 is coupled to a power plant as a source of vibrations by brackets (not shown) to which both axial ends of the inner cylinder body 10 are coupled by bolts etc.

Note that FIGS. 1-4 show a no-load state in which no static load of the power plant is applied to the engine mount A. In this state, the central axis of the inner cylinder body 10 is offset upward from that of the outer cylinder body 11. In a 1G state in which the engine mount A is attached to the vehicle body as described above and is subjected to the static load of the power plant, the rubber elastic body 12 is elastically deformed to displace the inner cylinder body 10 downward so that the central axis of the inner cylinder body 10 substantially matches that of the outer cylinder body 11.

The axial length of the inner cylinder body 10 is greater than that of the outer cylinder body 11, so that both axial ends of the inner cylinder body 10 protrude beyond the outer cylinder body 11. The outer peripheral shape of the inner cylinder body 10 is a non-circular shape other than a circular shape, as viewed in the axial direction. Specifically, the outer periphery of the inner cylinder body 10 is formed by flat surface portions having a linear profile and forming the upper and lower parts of the outer periphery, and curved surface portions having a curvilinear profile and forming the right and left parts of the outer periphery.

The rubber elastic body 12 has a pair of main spring portions 12a, 12b, a pair of axis-perpendicular stopper portions 12c, 12d, a first cover portion 12e, and a second cover portion 12f. The pair of main spring portions 12a, 12b extend on both sides in a first axis-perpendicular direction (in a lateral direction (a horizontal direction) of the automobile in this example embodiment) from the outer peripheral surface of the inner cylinder body 10, and are coupled to the inner peripheral surface of the outer cylinder body 11. The pair of axis-perpendicular stopper portions 12c, 12d protrude inward in a second axis-perpendicular direction (in a vertical direction in this example embodiment) perpendicular to the first axis-perpendicular direction, from those portions of the inner peripheral surface of the outer cylinder body 11 which face each other in the second axis-perpendicular direction. The pair of axis-perpendicular stopper directions 12c, 12d restrict relative movement between the outer and inner cylinder bodies 10, 11 in the second axis-perpendicular direction. The first cover portion 12e covers the outer peripheral surface of the inner cylinder body 10, and the second cover portion 12f covers the inner peripheral surface of the outer cylinder body 11. Through holes 12g, 12h extending in the axial direction are respectively formed near the upper and lower sides of the inner cylinder body 10 in the rubber elastic body 12.

Specifically, the main spring portions 12a, 12b extend downward from the inner cylinder body 10 so as to together form substantially an inverted-V shape, and elastically support the inner cylinder body 10 with respect to the outer cylinder body 10. The shape, size, etc. of the main spring portions 12a, 12b are designed so as to obtain predetermined vibration isolation characteristics. Both axial end faces of each main spring portion 12a, 12b are tilted axially inward toward the outside in a radial direction, and a radial outer end of each main spring portion 12a, 12b is located axially inside both axial end faces of the outer cylinder body 11.

The axis-perpendicular stopper portions 12c, 12d are provided along substantially the entire axial length of the outer cylinder body 11. The upper axis-perpendicular stopper portion 12c is provided so as to face the upper through hole 12g, and the lower axis-perpendicular stopper portion 12d is provided so as to face the lower through hole 12h. The lower axis-perpendicular stopper portion 12d has a substantially trapezoidal shape as viewed in the axial direction. The axis-perpendicular stopper portions 12c, 12d restrict relative movement between the inner and outer cylinder bodies 10, 11 in the second axis-perpendicular direction by contacting the inner cylinder body 10.

The axial stopper rubber elastic body 13 is provided so as to extend in a circumferential direction along the end face located on the one side (on the front side of the paper in FIG. 1) in the axial direction of the outer cylinder body 11, in the range from a position radially outside a portion where one (the right main spring portion 12b in FIG. 1) of the main spring portions, 12b, is placed to a position radially outside a portion where the lower axis-perpendicular stopper portion 12d is placed, as viewed in the axial direction. Specifically, this range is a range from a position near radially outside a circumferential central portion of the one main spring portion 12b to a position near radially outside a circumferential end (the right circumferential end in FIG. 1) located on the side of the main spring portion 12b of the lower axis-perpendicular stopper portion 12d. Although this range can refer to two different ranges, namely long and short ranges, this range refers to the shorter range in the example embodiment. An axial outer end face of the axial stopper rubber elastic body 13 has a corrugated shape. The axial stopper rubber elastic body 13 is coupled to the second cover portion 12f.

Note that although not shown in the figures, a stopper rubber elastic body that restricts relative movement between the outer and inner cylinder bodies 10, 11 in the axial direction is fitted on an end (the end located on the back side of the paper in FIG. 1) located on the other side in the axial direction of the inner cylinder body 10.

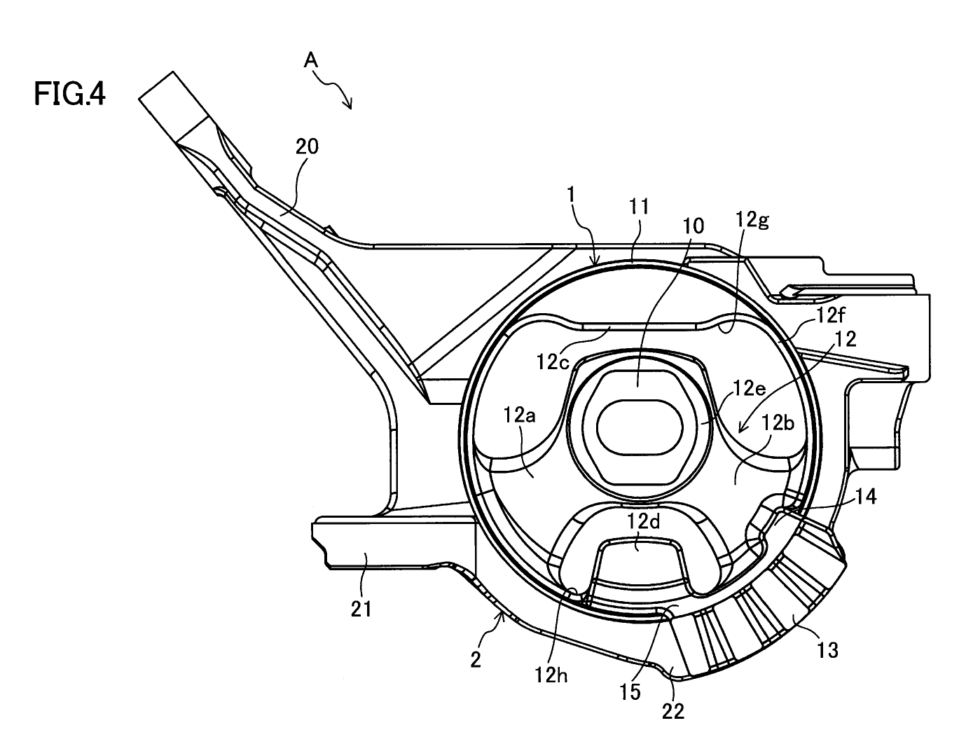

The cylindrical metal member 2 has a hollow cylindrical cylinder portion (not shown) and a flange 22 formed by bending radially outward by 90 degrees an end located on the one side (on the front side of the paper in FIG. 4) in the axial direction of the cylinder portion. The axial stopper rubber elastic body 13 restricts relative movement between the outer and inner cylinder bodies 10, 11 in the axial direction by contacting a bracket on the side of the power plant or the flange 22.

The mount main body 1 further includes a first coupling rubber elastic body 14 (corresponding to the “first coupling elastic body”) configured to hold the axial stopper rubber elastic body 13, and a second coupling rubber elastic body 15 (corresponding to the “second coupling elastic body”) configured to hold the axial stopper rubber elastic body 13. The first coupling rubber elastic body 14 is provided between the axial stopper rubber elastic body 13 and the one main spring portion 12b (the right main spring portion 12b in FIG. 1) to couple them together. The second coupling rubber elastic body 15 is provided between the axial stopper rubber elastic body 13 and the lower axis-perpendicular stopper portion 12d to couple them together. The first and second coupling rubber elastic bodies 14, 15 are formed integrally with the rubber elastic body 12 and the axial stopper rubber elastic body 13.

Specifically, the first coupling rubber elastic body 14 is provided so as to extend in the axial direction between a circumferential end (the upper end (the right end) in FIG. 1) located on the side of the main spring portion 12b of a radially inner edge of the axial stopper rubber elastic body 13, and a circumferential central portion of a radially outer edge (the lower end (the right end) in FIG. 1) of an end face located on the one side in the axial direction (on the front side of the paper in FIG. 1) of the main spring portion 12b. The first coupling rubber elastic body 14 protrudes radially inward from the inner peripheral surface of the outer cylinder body 11.

The second coupling rubber elastic body 15 is provided between a circumferential end (the lower end (the left end) in FIG. 1) located on the side of the axis-perpendicular stopper portion 12d of a radially inner edge of the axial stopper rubber elastic body 13, and a circumferential end (the right end in FIG. 1) located on the side of the main spring portion 12b of a base edge (the lower edge in FIG. 1) of an end located on the one side (on the front side of the paper in FIG. 1) in the axial direction of the axis-perpendicular stopper portion 12d.

[Advantages]

As described above, the vibration isolator according to the example embodiment includes the first coupling rubber elastic body 14 provided between the axial stopper rubber elastic body 13 and the one main spring portion 12b to couple them together, and the second coupling rubber elastic body 15 provided between the axial stopper rubber elastic body 13 and the axis-perpendicular stopper portion 12d to couple them together. Thus, the axial stopper rubber elastic body 13 can be reliably held at its position by the first and second coupling rubber elastic bodies 14, 15. This eliminates the need to provide a flange on the outer cylinder body 11 to place the axial stopper rubber elastic body 13 as in conventional examples, whereby the structure can be simplified and the cost can be reduced.

Moreover, the axial stopper rubber elastic body 13 is provided so as to extend in the circumferential direction in the range from the position radially outside the portion where the one main spring portion 12b is placed to the position radially outside the portion where the axis-perpendicular stopper portion 12d is placed, as viewed in the axial direction. This can simplify the respective structures of the first coupling rubber elastic body 14 provided between the axial stopper rubber elastic body 13 and the one main spring portion 12b to couple them together, and the second coupling rubber elastic body 15 provided between the axial stopper rubber elastic body 13 and the axis-perpendicular stopper portion 12d to couple them together.

Moreover, since the first and second coupling rubber elastic bodies 14, 15 are molded integrally with the rubber elastic body 12 and the axial stopper rubber elastic body 13, the axial stopper rubber elastic body 13 can be more reliably held at its position by the first and second coupling rubber elastic bodies 14, 15.

Both circumferential ends of each main spring portion 12a, 12b is more likely to be subjected to stress than the circumferential central portion thereof. Thus, providing the first coupling rubber elastic body 14 between one circumferential end of the one main spring portion 12b and the axial stopper rubber elastic body 13 reduces durability of the one main spring portion 12b.

According to the example embodiment, the first coupling rubber elastic body 14 is provided between the axial stopper rubber elastic body 13 and the circumferential central portion of the one main body portion 12b which is less likely to be subjected to stress. This can suppress reduction in durability of the one main spring portion 12b.

### Other Example Embodiments

Although the vibration isolator is applied to the engine mount in the above example embodiment, the present disclosure is not limited to this, and the vibration isolator may be applied a vehicle body mount, a suspension member mount, etc.

In the above example embodiment, the axial stopper rubber elastic body 13 is provided so that substantially the entire axial stopper rubber elastic body 13 is located axially outside the end face located on the one side in the axial direction of the outer cylinder body 11. However, the axial stopper rubber elastic body 13 need only be provided so that at least a part of the axial stopper rubber elastic body 13 is located axially outside the end face located on the one side in the axial direction of the outer cylinder body 11.

In the above example embodiment, the axial stopper rubber elastic body 13 is provided in the range from the position radially outside the portion where the one main spring portion 12b is placed to the position radially outside the portion where the lower axis-perpendicular stopper portion 12d is placed. However, the present disclosure is not limited to this. For example, the axial stopper rubber elastic body 13 may be provided in the range from a position radially outside the portion where the other main spring portion 12a is placed to a position radially outside the portion where the lower axis-perpendicular stopper portion 12d is placed, or may be provided in the range from a position radially outside the portion where either one of the main spring portions 12a, 12b is placed to a position radially outside the portion where the upper axis-perpendicular stopper portion 12c is placed. In the case where the axial stopper rubber elastic body 13 is provided in the range from the position radially outside the portion where the other main spring portion 12a is placed to the position radially outside the portion where the lower axis-perpendicular stopper portion 12d is placed, the first coupling rubber elastic body 14 is provided between the axial stopper rubber elastic body 13 and the other main spring portion 12a. On the other hand, in the case where the axial stopper rubber elastic body 13 is provided in the range from the position radially outside the portion where either one of the main spring portions 12a, 12b is placed to the position radially outside the portion where the upper axis-perpendicular stopper portion 12c is placed, the first coupling rubber elastic body 14 is provided between the axial stopper rubber elastic body 13 and the one of the main spring portions 12a, 12b, and the second coupling rubber elastic body 15 is provided between the axial stopper rubber elastic body 13 and the upper axis-perpendicular stopper portion 12c.

In the above example embodiment, the first coupling rubber elastic body 14 is shaped and structured as described above. However, the shape and structure of the first coupling rubber elastic body 14 are not limited to those described above as long as the first coupling rubber elastic body 14 is provided between the axial stopper rubber elastic body 13 and the one main spring portion 12b and couples them together. For example, the first coupling rubber elastic body 14 may be provided along substantially the entire radial length of the main spring portion 12b. However, the first coupling rubber elastic body 14 desirably has a small size for reduction in overall weight.

In the above example embodiment, the second coupling rubber elastic body 15 is shaped and structured as described above. However, the shape and structure of the second coupling rubber elastic body 15 are not limited to those described above as long as the second coupling rubber elastic body 15 is provided between the axial stopper rubber elastic body 13 and the lower axis-perpendicular stopper portion 12d and couples them together.

What is claimed is:

1. A vibration isolator, comprising:
an inner cylinder body;
an outer cylinder body provided around the inner cylinder body;
an elastic body provided between the inner and outer cylinder bodies to couple the inner and outer cylinder bodies together; and
an axial stopper elastic body that is provided so that at least a part of the axial stopper elastic body is located axially outside an end face located on one side in an axial direction of the outer cylinder body, and that restricts relative movement between the inner and outer cylinder bodies in the axial direction, wherein
the elastic body has a pair of main spring portions extending on both sides in a first axis-perpendicular direction from an outer peripheral surface of the inner cylinder body and coupled to an inner peripheral surface of the outer cylinder body, and an axis-perpendicular stopper portion protruding inward in a second axis-perpendicular direction perpendicular to the first axis-perpendicular direction from the inner peripheral surface of the outer cylinder body and restricting relative movement between the inner and outer cylinder bodies in the second axis-perpendicular direction, the vibration isolator further comprising:
a first coupling elastic body provided between the axial stopper elastic body and one of the main spring portions to couple the axial stopper elastic body and the one main spring portion together; and
a second coupling elastic body provided between the axial stopper elastic body and the axis-perpendicular stopper portion to couple the axial stopper elastic body and the axis-perpendicular stopper portion together.

2. The vibration isolator of claim 1, wherein
the axial stopper elastic body is provided so as to extend in a circumferential direction in a range from a position radially outside a portion where the one main spring portion is placed to a position radially outside a portion where the axis-perpendicular stopper portion is placed, as viewed in the axial direction.

3. The vibration isolator of claim 1, wherein
the first and second coupling elastic bodies are molded integrally with the elastic body and the axial stopper elastic body.

4. The vibration isolator of claim 1, wherein
the first coupling elastic body is provided between the axial stopper elastic body and a circumferential central portion of the one main spring portion.
